(19) United States
(12) Patent Application Publication
(10) Pub. No.: US 2021/0141078 A1
(43) Pub. Date: May 13, 2021

(54) DETECTION SYSTEM AND METHOD FOR CHARACTERIZING TARGETS

(71) Applicant: Veoneer US, Inc., Southfield, MI (US)

(72) Inventor: Majid Ahmadloo, Lowell, MA (US)

(73) Assignee: Veoneer US, Inc., Southfield, MI (US)

(21) Appl. No.: 16/679,437

(22) Filed: Nov. 11, 2019

(51) Int. Cl. G01S 13/86; G01S 13/42

(52) U.S. Cl. CPC G01S 13/865; G01S 13/42

(57) ABSTRACT

A detection system detects objects in an environment around a vehicle. The detection system includes a radar system and a LiDAR system, each configured to detect objects. The radar system and LiDAR system are positioned to have a shared frame of reference around the vehicle.

### FIELD OF THE TECHNOLOGY

The subject disclosure relates to detection systems for vehicles, and more particularly to detection systems using LiDAR and radar.

### BACKGROUND OF THE TECHNOLOGY

Vehicles often include detection systems which can be used in Adaptive Driver Assistance Systems (ADAS), self-driving automotive applications, and the like. These detections systems collect and process data on targets in the surrounding environment to characterize targets and determine whether a collision is likely. Detection systems typically rely on multiple levels of redundancies for detection and verification of targets, reduction of false alarms, and to significantly decrease the possibly of missing targets (for example, due to weather conditions such as fog, rain, or heavy snow at which LiDAR may fail to detect certain distances). This is often combated with the utilization of multiple radar and LiDAR units on the same vehicle to verify detection data, reject false alarms, and compensate for the short comings of other units on the vehicle. However, use of a large number of different detection units can be costly, unsightly, require a substantial amount of processing power, and in many cases, can be impractical for commercial use.

### SUMMARY OF THE TECHNOLOGY

In light of the needs described above, in at least one aspect, the subject technology relates to a detection system which can accurately and reliably detect objects using both LiDAR and radar without requiring multiple units and a complex processing system.

In at least one aspect, the subject technology relates to a detection system for detecting objects in an environment around a vehicle. The detection system includes a radar system and a LiDAR system. The radar system is configured to detect the objects and the LiDAR system is configured to detect the objects. The radar system and LiDAR system are positioned to have a shared frame of reference around the vehicle.

In some embodiments, the detection system includes an actuator configured to rotate the radar system and LiDAR system about a shared axis such that the radar system and LiDAR system scan the environment. The shared axis can be a vertical axis and the radar system and LiDAR system can be configured to rotate about the shared axis to scan the environment in azimuth. In some cases, the detection system includes a housing coupled to the vehicle, the housing containing the radar system and the LiDAR system. In some embodiments, the radar system and LiDAR system are fixedly coupled to the vehicle at a shared position with respect to an azimuth plane.

In some embodiments, the radar system is configured to detect range data and the LiDAR system is configured to detect range data and angular data. The detection system can then be configured to compare range data between the radar system and LiDAR system to identify a shared target and determine an angular position of the shared target based on angular data from only the LiDAR system. In some cases, the radar system is configured to detect range data with a detection antenna having a single channel.

In at least one aspect, the subject technology relates to a detection system for detecting objects in an environment around a vehicle. The detection system includes a radar system and LiDAR system. The radar system has a transmission antenna configured to transmit a radar signal and a detection antenna configured to receive a radar return signal. The LiDAR system has at least one light transmitter configured to transmit light and at least one light sensor configured to receive return light. The radar system and LiDAR system are positioned on the vehicle to have a shared frame of reference around the vehicle.

In some embodiments, the detection system includes a housing containing the radar system and the LiDAR system, the housing sealed to protect the radar system and LiDAR system from the environment. In some cases, the housing is coupled to the vehicle via attachment of the housing to a support member, the support member attached to the vehicle and extending along a vertical axis. An actuator can then be configured to rotate the support member about the vertical axis to allow the radar system and LiDAR system to scan in the azimuth direction. The radar system and the LiDAR system can be fixedly coupled to the vehicle at a shared position with respect to an azimuth plane.

In some embodiments, the radar system is configured to detect range data and the LiDAR system is configured to detect range data and angular data. The detection system can then be configured to compare range data between the radar system and LiDAR system to identify a shared target and determine an angular position of the shared target based on angular data from the LiDAR system. In some cases, the radar system is configured to detect range data with a detection antenna having a single channel.

In some embodiments, the detection includes a processing module connected to the LiDAR system and the radar system to receive measured data from the LiDAR system and radar system. The processing module can be configured to estimate a range for each object based on the measured data. The processing module can further be configured to compare an estimate of reliability of the LiDAR system and an estimate of reliability of the radar system, based on the range for each object, to determine a more reliable system for each object. The processing module is further configured to characterize each object based predominately on measured data from the more reliable system for said object. In some cases, the processing module is further configured to receive data related to environmental conditions. The processing module can then compare an estimate of reliability of the LiDAR system and an estimate of reliability of the radar system, based on the environmental conditions, to determine a more reliable system. Each object can then be characterized, by the processing module, based predominately on measured data from the more reliable system.

### BRIEF DESCRIPTION OF THE DRAWINGS

So that those having ordinary skill in the art to which the disclosed system pertains will more readily understand how to make and use the same, reference may be had to the following drawings.

FIG. 1 is a front view of a detection system on a vehicle within an environment in accordance with the subject technology.

FIG. 2 is a block diagram of a detection system on a vehicle within an environment in accordance with the subject technology.

FIG. 3 is a schematic diagram of a detection system in accordance with the subject technology.

FIGS. 4A-4C are partially exploded views of detection systems in accordance with the subject technology.

### DETAILED DESCRIPTION

The subject technology overcomes many of the prior art problems associated with vehicle detection systems. In brief summary, the subject technology provides a detection system that utilizes both a LiDAR system and a radar system at substantially the same position on the vehicle, within a housing, rotating around a shared axis, and/or sharing a frame of reference. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always be at a higher elevation).

Referring now to FIG. 1, a detection system 100 for detecting objects in an environment 102 around a vehicle 104 is shown. The detection system 100 includes both a LiDAR and radar system within a shared exterior housing 106, as discussed in more detail below. A window 108 through the otherwise solid housing 106 provides the LiDAR system with line of sight of the surrounding environment 102. The window 108 can be a translucent material such as glass or plastic material to allow light to pass through while still protecting the internal components of the detection system 100. The housing 106 also acts as a radome for the radar system, protecting the radar system while allowing signals to and from the radar system to pass therethrough. The housing 106 and detection system 100 are connected to the vehicle 104 via a support member 110 which is attached to the top of the vehicle 104 and enters the bottom of the housing 106. An actuator 112, which can be a motor or the like, is connected to the support member 110 and configured to rotate the support member 110. The support member 110 generally runs vertically, forming a vertical axis “y”, and, in response to a command from the detection system 100, the actuator 112 rotates the support member 110 about the vertical axis y. Rotation of the support member 110 around the vertical axis y changes the field of view of LiDAR and radar systems (i.e. the direction of transmitted and received signals) horizontally, allowing an azimuth scan of the environment 102.

Referring now to FIG. 2, a block diagram of a vehicle 204 with a simplified detection system 200 is shown. The vehicle 204 is traveling through an environment 202 which includes a number of objects 214. The detection system 200 includes a LiDAR system 216 and a radar system 218 which are combined in a shared housing. In general, both the LiDAR system 216 and radar system 218 include the necessary components for detecting the targets 214 within the environment 202 around the vehicle 204 as typically included in LiDAR and radar systems, respectively. The LiDAR system 216 includes one or more light transmitters 220 configured to transmit a light beam 222 into the environment 202. After a transmitted light beam 222 has deflected off a target 214, a return light beam 224 returns to the detection system 200 for receipt by one or more light receivers 238. Notably, the LiDAR system 216 can also include an array of light transmitters and receivers such that multiple light beams 222 can be sent and received at a time. The radar system 218 includes a transmission antenna 228 configured to transmit radar signals 230, and a detection antenna 232 configured to receive radar return signals 234 returning from targets 214. The transmission antenna 228 can be one single channel transmission antenna while the detection antenna 232 can be one single channel detection antenna. In general, the LiDAR system 216 and the radar system 218 are close enough that they moved together as the vehicle 204 moves and share a frame of reference, particularly in the azimuth direction (i.e. an “x-z” plane). For example, although shown slightly offset for illustrative purposes, the radar system 218 and LiDAR system 216 can be substantially in the same location in the azimuth direction, although they are at slightly different heights in the vertical (y-axis) direction, to facilitate the sharing of information, as discussed below.

Both the LiDAR system 216 and radar system 218 are connected to a shared processing module 236. The processing module 236 can include a processor connected to or including memory, and generally, any other necessary components for carrying out processing functions as discussed herein, or the processing functions of the detection system as a whole, such as individual application specific integrated circuits or multiple separate processors and/or memory banks. The processing module 236 communicates with the LiDAR system 216 and radar system 218 to facilitate the transmission of the signals 222, 230, and receives and stores data related to the return signals 226, 234 and the detection process generally. The received return signals 226, 234 are processed and relevant detection data is stored in the processing module 236. For example, for the LiDAR system 216, a magnitude of each return signal 226 and range of the corresponding target 214 as derived from the return signal 226 can be processed and stored. The processing module 236 can also process angular data from the LiDAR system related to return angles of the returning signals 226. For the radar system 218, a range of a corresponding target 214 can be measured from the return signals 234. In some cases, the radar system 218 can also detect angular data.

The detection system 200 is fixed to the vehicle 204 via a support member 210 which extends along a vertical axis “y”. An actuator (not distinctly shown) rotates the support member 210 about the vertical axis y. The detection system 200, including the LiDAR system 216 and radar system 218, are connected to the support member 210 and therefore rotate around the vertical axis y as the support member 210 rotates. Rotation of the LiDAR and radar systems 216, 218 causes the field of view of each system 216, 218 to change in the azimuth direction, giving the detection system 200 a full 360 degrees field of view in azimuth.

Given their proximity and shared rotation around the vertical axis y, the LiDAR and radar systems 216, 218 rotate at the same speed and maintain a shared frame of reference as the detection system 200 rotates, and can reliably share data. The shared frame of reference includes a substantially shared position on the vehicle, shared movement speed, and shared reference angle of detected objects. This can lead to further benefits, including a need for a much less robust radar system 218 and less processing power, if desired. For example, both the LiDAR and radar systems 216, 218 can collect range data on the targets, sending that data to the processing module 236 where the data can be compared. A range estimate for the each target 214 can be determined based on a comparison and/or combination of the range data from the LiDAR system 216 and radar system 218, or be taken from only one of the systems 216, 218 depending on the expected reliability of each system 216, 218 in a given scenario. Accurately characterizing a target 214 also involves determining a relative position of the target 214 with respect to the vehicle 204, which requires some consideration of angular data. As such, radar systems normally detect and process angular return data in addition range data to characterize targets. This requires the radar system to employ an array of receiving antennas to detect angle of return signal arrival and calculate return signal phase differences using mathematical calculations (fast Fourier transform). However, LiDAR systems are able to calculate return signal angles for their returns with a high degree of precision. Therefore in the present detection system 200, since the systems 216, 218 have a shared frame of reference, the range data from the LiDAR system 216 and radar system 218 can be compared by the processing module 236 to find substantially similar range data for a target 214 and identify it as a shared target 214. The processing module 236 can then rely exclusively on the angular data from the LiDAR system 216 to characterize the position (i.e. expected angle with respect to the detection system 200) for that target 214. This eliminates the need for more than one transmitting antenna or more than one receiving antenna within the radar system 218, and allows the radar system 218 to have only a single channel transmission and receiving antenna. Further, with no need for the radar system 218 to process angular data separately, the detection system 200 requires significantly less processing power. This simplifies both the hardware and software of the detection system 200 while maintaining or even improving detection performance, which can result in cost savings and reduced installation complexity.

In some cases, the detection system 200 can also receive data from other sensors on the vehicle, or from additional sensors within the detection system, which reports on current conditions of the environment 202. This data can be used to determine a more reliable system 216, 218 at a given time. For example, since LiDAR systems generally tend to be more susceptible to inaccuracies caused by weather (e.g. fog, rain, or heavy snow), the detection system 200 can rely on data from the radar system 218, either predominately or exclusively, for range data during such conditions. If the radar system 218 measures angular data in addition to range data, the radar system 218 can be relied on, predominately or exclusively, for all data during adverse conditions. Similarly, LiDAR systems are often more reliable at shorter ranges, while radar systems perform better at longer ranges. Thus, the LiDAR system 216 and radar system 218 could have their reliability estimated based on the measured distance of the target, and the extent to which each system 216, 218 was relied on could be based on the estimated reliability for a given target. Alternatively, data from both systems 216, 218 can be used for redundancy for detection and verification of targets and reduction of false alarms, with some preference optionally being given to the more reliable system 216, 218 based on the circumstances within the environment 202.

Referring now to FIG. 3, a schematic diagram of an arrangement of a detection system in accordance with the subject technology as shown. Some components of the detection system 300 have been omitted from FIG. 3 for the sake of simplicity, but it should be understood that the detection system can function and include components similar to the other detections systems discussed herein, except where otherwise indicated. The housing 306 can be affixed to a vehicle via a support member, as in the arrangement shown in FIG. 1, to rotate around the vertical axis y.

The detection system 300 includes a radar system 318 fixed within the housing 306 vertically above the LiDAR system 316 along the y axis. The housing 306, while generally solid, includes two separate windows 340, 342 allowing light to pass through the housing 306. The first window 340 allows for the transmission of light beams from the LiDAR system 316 while the second window 342 allows return signals to pass therethrough for detection by receivers of the LiDAR system 316. The LiDAR system 316 includes an internal mirror mechanism 344 which can direct outgoing and returning light beams while keeping the LiDAR system 316 compact.

The radar system 318 includes a radar board 352 with a single channel transmission antenna 328 and a single channel receive antenna 332. The transmission antenna 328 and receive antenna 332 are connected to an MMIC 346, respectively, by a transmission antenna feed line 348 and a receive antenna feed line 350. The MMIC 346 helps perform typical radar transmission and receipt functions. No windows through the housing 306 are required adjacent to the radar system 318, as the radar signals can travel through the housing 306 without significant interference. The radar system 318 can be tuned based on its particular position and the needs of the detection system 300. This can include changes to frequency band, gain, and the like, and can account for any interference due to the interaction with the surrounding housing 306, which can be a metallic enclosure. In the example shown in FIG. 3, the radar system 318 sits directly on top of the LiDAR system 316, allowing it to be integrated into the housing 306 even when the housing 306 is designed primarily for the LiDAR system 316. Since the LiDAR system 316 must be mounted to have line of sight on targets around the vehicle, the detection system 300 will often be mounted above a vehicle, as shown in FIG. 1. By contrast, radar systems don't require line of sight and therefore are typically fitted into the existing structure of a vehicle, such as behind a bumper or emblem. However, in such a case, any change in the installation fixture (e.g. the bumper) can result in unexpected changes in the radar system and negatively impact performance. Thus, installing the radar system 318 in a location normally reserved for only a LiDAR system, such as on top of the vehicle, provides the radar system 318 with an unobscured path which is not affected by modifications to components of the vehicle, such as the bumper. Further, the housing 306 can serve as the radome for the radar system 318, which eliminates the need for a separate, independent radome. As such, the housing 306 is normally sealed around the radar system 318 and LiDAR system 316, protecting them from the surrounding environment.

Referring now to FIGS. 4A-4C, schematic diagrams of detection systems 400A, 400B, 400C (generally 400) in accordance with the subject technology are shown. Most of the outer housing is omitted to better show internal components of the detection systems 400. Radar systems are typically smaller than LiDAR systems, and thus, the radar system 418, 454 portion of the detection system can be fixed at various locations, as shown in FIGS. 4A-4C. The detection systems 400 can function and include components similar to the other detections systems discussed herein, except where otherwise indicated. In particular, the detection systems 400a-400c are similar to one another, aside from differences in the radar systems 418, 454, and the location at which each radar system 418, 454 is positioned within the respective detection system 400. Note that in the detection systems 400, exterior portions of the housing are omitted to better show the interior structure. Further, the specific arrangements shown FIG. 4A, 4B, 4C are exemplary only, and it should be understood that other arrangements could be used.

In general, the lower support 456 can represent the bottommost portion of the housing. The rotating support member can either attach directly to the lower support 456, or pass through the lower support and attach to another support structure within the housing to rotate the entire detection system 400. The components of the LiDAR system are generally on top of a support platform 458. An interior support member 460 is affixed within the housing which provides a rigid structural support upon which other components of the LiDAR system can be fixed. Apertures 462, 464 through an interior protective housing 466 and the outer housing give the LiDAR transmitters and receivers (not distinctly shown) a field of view of the surrounding environment. The LiDAR transmitters can be affixed to, and supported by, a first side support 468 for transmitting light beams out of the first aperture 462 for the LiDAR system. The LiDAR receivers can be supported by the second side support 470 for receiving returning light beams through the second aperture 464.

Since the radar system is generally much smaller than the LiDAR system in a given detection system 400, the radar systems 418, 454 can be incorporated in a variety of positions around the LiDAR system. The systems 400A, 400B include a radar system 418 positioned in a horizontal orientation. FIG. 4A shows an arrangement where the radar system 418 is positioned on top of (i.e. vertically above) the LiDAR components. The radar board 452 can then be physically connected to the interior and side support structures (460, 468, 470) of the LiDAR system. By contrast, FIG. 4B shows an arrangement where the radar module is below (i.e. vertically under) the LiDAR system components. In this arrangement, the radar board 452 can be physically connected to the bottom of the support platform 458.

Both systems include components similar to the radar system 318. To that end, the radar systems 418 include a radar board 452 with a single channel transmission antenna 428 and a single channel receive antenna 432 connected to an MMIC 446 by respective transmission antenna feed line 448 and receive antenna feed line 450. All of these components are functionally the same as the respective components in FIG. 3, and therefore are not discussed in further detail herein.

FIG. 4C shows the radar system 454 in a vertical orientation, where the radar board 452 is mounted directly to the interior protective housing 466 of the LiDAR system. The vertical orientation necessitates a different antenna configuration to scan the area around the vehicle. As such, the radar system 454 antenna 472 can be a patch fed array antenna. A waveguide horn (not shown distinctly) can be utilized to direct the signals from the antenna 472 in the correct direction to scan in the azimuth direction as the detection system 400C rotates. Note that while the specific antennas discussed with respect to FIGS. 4A, 4B, and 4C, have been found to be effective for their intended purpose, they are exemplary only. Other antennas, as are known in the art, could be used instead of the antennas discussed herein.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements (e.g. transmitters, receivers, and the like) shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A detection system for detecting objects in an environment around a vehicle, the detection system comprising:
a radar system configured to detect the objects; and
a LiDAR system configured to detect the objects,
wherein the radar system and LiDAR system are positioned to have a shared frame of reference around the vehicle.

2. The detection system of claim 1, further comprising:
an actuator configured to rotate the radar system and LiDAR system about a shared axis such that the radar system and LiDAR system scan the environment.

3. The detection system of claim 2, wherein the shared axis is a vertical axis and the radar system and LiDAR system are configured to rotate about the shared axis to scan the environment in azimuth.

4. The detection system of claim 1, further comprising a housing coupled to the vehicle, the housing containing the radar system and the LiDAR system.

5. The detection system of claim 1, wherein the radar system and LiDAR system are fixedly coupled to the vehicle at a shared position with respect to an azimuth plane.

6. The detection system of claim 1, wherein:
the radar system is configured to detect range data;
the LiDAR system is configured to detect range data and angular data; and
the detection system is configured to compare range data between the radar system and LiDAR system to identify a shared target and determine an angular position of the shared target based on angular data from only the LiDAR system.

7. The detection system of claim 6, wherein the radar system is configured to detect range data with a detection antenna having a single channel.

8. A detection system for detecting objects in an environment around a vehicle, the detection system comprising:
a radar system having a transmission antenna configured to transmit a radar signal and a detection antenna configured to receive a radar return signal; and
a LiDAR system having at least one light transmitter configured to transmit light and at least one light sensor configured to receive return light,
wherein the radar system and LiDAR system are positioned on the vehicle to have a shared frame of reference around the vehicle.

9. The detection system of claim 8, further comprising a housing containing the radar system and the LiDAR system, the housing sealed to protect the radar system and LiDAR system from the environment.

10. The detection system of claim 9, wherein:
the housing is coupled to the vehicle via attachment of the housing to a support member, the support member attached to the vehicle and extending along a vertical axis; and
an actuator configured to rotate the support member about the vertical axis to allow the radar system and LiDAR system to scan in the azimuth direction.

11. The detection system of claim 8 wherein the radar system and the LiDAR system are fixedly coupled to the vehicle at a shared position with respect to an azimuth plane.

12. The detection system of claim 8, wherein:
the radar system is configured to detect range data;
the LiDAR system is configured to detect range data and angular data; and
the detection system is configured to compare range data between the radar system and LiDAR system to identify a shared target and determine an angular position of the shared target based on angular data from the LiDAR system.

13. The detection system of claim 12, wherein the radar system is configured to detect range data with a detection antenna having a single channel.

14. The detection system of claim 8, further comprising a processing module connected to the LiDAR system and the radar system to receive measured data from the LiDAR system and radar system.

15. The detection system of claim 14, wherein the processing module is configured to:
estimate a range for each object based on the measured data;
compare an estimate of reliability of the LiDAR system and an estimate of reliability of the radar system, based on the range for each object, to determine a more reliable system for each object; and
characterize each object based predominately on measured data from the more reliable system for said object.

16. The detection system of claim 14, wherein the processing module is configured to:
receive data related to environmental conditions;
compare an estimate of reliability of the LiDAR system and an estimate of reliability of the radar system, based on the environmental conditions, to determine a more reliable system; and
characterize each object based predominately on measured data from the more reliable system.
